(19) United States
(12) Patent Application Publication
(10) Pub. No.: US 2013/0078066 A1
(43) Pub. Date: Mar. 28, 2013

(54) SINGLE ENGINE SURFACE CLEANING VEHICLE

(71) Applicant: Roger Vanderlinden, Burlington (CA)

(72) Inventor: Roger Vanderlinden, Burlington (CA)

(21) Appl. No.: 13/590,148

(22) Filed: Aug. 20, 2012

Related U.S. Application Data
(60) Provisional application No. 61/525,397, filed on Aug. 19, 2011.

(51) Int. Cl. B65F 3/14; B60S 5/00; E01H 1/00

(52) U.S. Cl. CPC B65F 3/14; E01H 1/00; B60S 5/00
USPC 414/539; 29/401.1; 29/825

(57) ABSTRACT

A single-engine surface cleaning vehicle comprises a pre-built conventional truck chassis and a forwardly mounted internal combustion engine. A hydraulic pump has a mechanical input connected to the mechanical output of the power take off unit, and a hydraulic output. A hydraulic drive motor has a hydraulic input connected to the hydraulic output of variable displacement hydraulic pump, and a mechanical output connected in driving relation to the drive input of the rear differential and drive axle assembly. The rear drive wheels are drivable by the internal combustion engine through the power take off unit, the variable displacement hydraulic pump, the hydraulic drive motor and the differential and axle assembly. A debris hopper is mounted on the pre-built conventional truck chassis. A debris loading apparatus is operatively mounted on the pre-built conventional truck chassis and is connected in debris depositing relation to the debris hopper.

### RELATED APPLICATION

This application is a non-provisional application claiming priority from U.S. Provisional Patent Application Ser. No. 61/525,397 filed on Aug. 19, 2011, which is herein incorporated by reference.

### FIELD OF THE INVENTION

The present invention relates to surface cleaning vehicles for cleaning horizontal surfaces such as streets, parking lots, sidewalks, and the like, and more particularly to such surface cleaning vehicles that power all of their mechanical functions from a single internal combustion engine.

### BACKGROUND OF THE INVENTION

Conventional surface cleaning vehicles, such as street cleaning vehicles and sidewalk cleaning vehicles, typically employ an internal combustion engine to provide power to the vehicle's drive wheels. This is same internal combustion engine may also provide power to the various operative components of the vehicle, such as the cleaning apparatus, air suction fans, and so on, which causes an inherent problem. These vehicles typically need to drive at varying speeds, including very low speeds; however, the various operative components require power generally at a more constant level, and generally not in synchronization with the power required to propel the vehicle.

For instance, surface cleaning vehicles are typically driven on roads between job sites at normal roadway speeds of perhaps thirty to fifty miles per hour (fifty to eighty kilometers per hour). However, during use at a job site, surface cleaning vehicles must be driven at very slow speeds of perhaps about one to five to ten miles per hour. In heavy dirt and debris, typically the travel speed is about one mile per hour, since maximum rate at which dirt and debris can be effectively cleaned from a paved surface.

Driving surface cleaning vehicles at such slow speeds presents a very considerable and significant problem. The vehicle's internal combustion engine, typically a diesel engine or a conventional gasoline engine, must always run at about 1500 to 2000 r.p.m., or even faster, in order to produce the necessary horsepower to power the various operative components of the surface cleaning vehicle; however, at this engine speed, even employing a special transmission having a very low first gear, a surface cleaning vehicle would travel at a minimum speed of about five miles per hour, which is significantly faster than the required one mile per hour for cleaning heavy debris. Accordingly, it is common to continually apply the brakes of the surface cleaning vehicle while cleaning heavy debris, in order to achieve the required low speed. Since the surface cleaning vehicle is in very low gear, the forward driving force is extremely powerful, and accordingly, brakes tend to wear out extremely quickly.

One simple possible solution to this above described problem is use a drive line reduction transmission in line with the conventional transmission in order to achieve a very low overall gear ratio. Another large company produces such a surface cleaning vehicle; however, it has been found that this surface cleaning vehicle still requires braking to run slowly enough in heavy debris. Further, drive line reduction transmissions are expensive and do not fully solve the above stated problems.

In order to overcome the dichotomy of providing sufficient power to drive the cleaning apparatus, while travelling at a sufficiently slow speed, many truck mounted surface cleaning vehicles use a main internal combustion engine and an auxiliary internal combustion engine. The main internal combustion engine is used with a conventional transmission to drive the surface cleaning vehicle during travel between job sites and while performing its cleaning operation. The auxiliary internal combustion engine is used to power the cleaning apparatus to achieve varying and sufficient broom speeds while not affecting the travel speed vehicle. However, such surface cleaning vehicles still have the problem of not being able to travel slowly enough, especially during heavy dirt and debris removal where extremely slow speeds are required, since a conventional transmission is used. Moreover, the inclusion of a second internal combustion engine increases the cost of the surface cleaning vehicle, maintenance costs, and fuel costs.

Also known are specially designed hydraulically driven surface cleaning vehicles that use a single internal combustion engine to power a hydraulic drive system that turns the rear drive axle of the vehicle. Such hydraulically driven surface cleaning vehicles are not built on a separate conventional truck chassis, but instead are entirely integrally designed and also manufactured as an entire unit from the “ground up” as “purpose-built” vehicles. In spite of the fact that these hydraulically driven surface cleaning vehicles are specifically designed and manufactured to accomplish a known and well-defined task, historically are fraught with significant maintenance and reliability problems. Typically, they have a low top speed, tend to have poor higher speed handling and braking characteristics, are mechanically unreliable, have high maintenance costs. Accordingly, they have not been the surface cleaning vehicle of choice in many circumstances.

It should be understood that shortcomings of the “purpose-built” vehicles are comparative in nature. The features as set forth above are compared to surface cleaning vehicles that are built on a separate conventional truck chassis, which typically do not experience these above stated problems. These convention trucks have been designed and refined by large companies over many years, and are produced and sold in very large sales volumes. Accordingly, they have reached a point of refinement where they tend to have a useful top speed, good higher-speed handling and braking characteristics, are mechanically reliable, and have reasonable maintenance costs. It is virtually impossible to match this amount of refinement through “purpose-built” development for of surface cleaning vehicles.

Further, in many jurisdictions, there are many tough new legislative standards and regulations concerning vehicle safety. It is extremely difficult and costly to go through the process of meeting these standards and regulations. Pre-build conventional truck chassis already meet all of these standards and regulations, thus cutting a significant amount of cost and time from the development of a surface cleaning vehicle.

Another approach to the above described problem of providing sufficient horsepower to the cleaning apparatus while driving the surface cleaning vehicle at very slow speeds is to directly drive the rear axle differential through a conventional transmission, and to hydraulically power the cleaning apparatus. In one example of such a surface cleaning vehicle, a variable displacement hydraulic piston pump is driven by the engine's driveshaft and powers the cleaning apparatus. Therefore, the power available to the cleaning apparatus is controllable. The inherent problem with this design is that the engine speed must remain above about 1500 r.p.m. in order to produce sufficient horsepower to drive the vehicle and power the cleaning apparatus. Accordingly, the vehicle cannot be driven slowly enough in heavy debris without riding the brakes.

In an attempt to solve the above discussed problems associated with various types of surface cleaning vehicles, one manufacturer has introduced a single internal combustion engine surface cleaning vehicle built on a commercial truck chassis. This surface cleaning vehicle employs a diesel engine driving a conventional transmission and rear differential arrangement. Additionally, a switching gearbox is installed in-line between the transmission and the conventional single input rear differential. For travel between job sites, the internal combustion engine drives the rear wheels through the transmission, the main “straight-through” input of the switching gearbox, and rear differential, essentially as if the switching gearbox had not replaced the conventional axle. A power take-off unit is operatively mounted on the transmission, with a hydraulic variable displacement pump and a hydraulic gear pump driven by the power take-off unit. The hydraulic variable displacement pump powers a first hydraulic drive motor operatively coupled to the auxiliary input of the switching gearbox, as opposed to being coupled to the main “straight-through” input. During cleaning, the switching gearbox is driven by the first hydraulic drive motor, not directly by the vehicle's engine through the conventional driveshaft. In any event, the output of the switching gearbox directly drives the one input of the rear differential.

Even through limited use, it has become readily apparent that this single internal combustion engine surface cleaning vehicle has not been gaining market acceptance, mainly due to the fact that switching gear boxes tend to be expensive, representing a significant cost relative to the cost of the entire surface cleaning vehicle, which is highly undesirable. Further, a transmission that can accept a power take-off unit typically costs several thousand dollars more than a conventional transmission.

U.S. Pat. No. 6,073,720 issued Jun. 13, 2000, to Vanderlinden, discloses a surface cleaning vehicle comprising a street cleaning apparatus, and an engine having a mechanical power output. A differential and axle assembly has a first drive input drivable in a first phase by the mechanical power output of the engine through a mechanical coupling and a second drive input drivable in a second phase by the mechanical power output of the engine through a hydraulic power system. A rear drive axle is drivable through the rear differential by a selected one of the first drive input and the second drive input, so as to propel the surface cleaning vehicle. A selectably operable switching mechanism is included to effect a selected one of the first and second phases. Although this arrangement works well, it still has one inherent drawback, as do other prior art surface cleaning vehicles. The cumulative cost of a transmission and drive axle used to drive the rear differential and rear drive axle for travel of the vehicle at high speeds, and the hydraulic power system for travel of the vehicle at low speeds, is quite significant, and therefore prohibitive.

It is an object of the present invention to provide a single internal combustion engine surface cleaning vehicle.

It is yet another object of the present invention to provide a single internal combustion engine surface cleaning vehicle that can be driven at appropriately slow speeds while cleaning heavy debris and make available sufficient power for the cleaning apparatus.

It is yet another object of the present invention to provide a single internal combustion engine surface cleaning vehicle that is inherently less expensive to produce than prior art models.

It is yet another object of the present invention to provide a single engine internal combustion engine surface cleaning vehicle wherein the space between the frame rails is generally open.

It is yet another object of the present invention to provide a single engine internal combustion engine surface cleaning vehicle wherein the space between the frame rails is generally open, to allow for a suction hose to be generally centrally located between the frame rails.

### SUMMARY OF THE INVENTION

In accordance with one aspect of the present invention there is disclosed a novel single-engine surface cleaning vehicle comprising a pre-built conventional truck chassis defining a front end and back end, and having mounted thereon an internal combustion engine disposed toward the front end of the truck chassis and having a drive output, steerable front wheels, a rear differential and rear axle assembly having a main input, and rear drive wheels mounted on the rear differential and rear axle assembly. A hydraulic pump has a mechanical input connected in driven relation to the drive output of the internal combustion engine, and a hydraulic output. A hydraulic drive motor has a hydraulic input connected in hydraulic relation to the hydraulic output of variable displacement hydraulic pump, and a mechanical output connected in driving relation to the drive input of the rear differential and drive axle assembly. The rear drive wheels are drivable by the internal combustion engine through the drive output of the internal combustion engine, the hydraulic pump, the hydraulic drive motor and the differential and axle assembly. A debris hopper is mounted on the pre-built conventional truck chassis. A debris loading apparatus is operatively mounted on the pre-built conventional truck chassis and is connected in debris depositing relation to the debris hopper.

In accordance with another aspect of the present invention there is disclosed a novel method of manufacturing a single-engine surface cleaning vehicle, the method comprising the steps of a) providing a pre-built conventional truck chassis defining a front end and back end, and having mounted thereon an internal combustion engine disposed toward the front end of the truck chassis and having a drive output, steerable front wheels, a rear differential and rear axle assembly having a main input, rear drive wheels mounted on the rear differential and rear axle assembly; b) connecting the mechanical input of a hydraulic pump in driven relation to the drive output of said internal combustion engine; c) connecting the hydraulic input of a hydraulic drive motor in hydraulic relation to the hydraulic output of said hydraulic pump; d) connecting the mechanical output of said hydraulic drive motor in driving relation to the main input of said rear differential and drive axle assembly; wherein the rear drive wheels are drivable by the internal combustion engine through the power take-off unit, the variable displacement hydraulic pump, the hydraulic drive motor and the differential and axle assembly; e) mounting a debris hopper on the pre-built conventional truck chassis; f) operatively mounting a debris loading apparatus on the pre-built conventional truck chassis; and g) connecting the debris loading apparatus in debris depositing relation to the debris hopper.

In accordance with another aspect of the present invention there is disclosed a novel single-engine surface cleaning vehicle comprising a pre-built conventional truck chassis defining a front end and back end, and having mounted thereon an internal combustion engine disposed toward the front end of the truck chassis and having a drive output, steerable front wheels, a rear differential and rear axle assembly having a main input, and rear drive wheels mounted on the rear differential and electric generator rear axle assembly; an electric generator having a mechanical input connected in driven relation to the drive output of the internal combustion engine, and an electrical output; an electric drive motor having an electric input connected in electrically conductive relation to the electric output of the electric generator, and a mechanical output connected in driving relation to the main input of the rear differential and drive axle assembly; wherein the rear drive wheels are drivable by the internal combustion engine through the electric generator, the electric drive motor, the electric drive motor and the differential and axle assembly; a debris hopper mounted on the pre-built conventional truck chassis; and a debris loading apparatus operatively mounted on the pre-built conventional truck chassis, and connected in debris depositing relation to the debris hopper.

In accordance with another aspect of the present invention there is disclosed a novel method of manufacturing a single-engine surface cleaning vehicle, the method comprising the steps of a) providing a pre-built conventional truck chassis defining a front end and back end, and having mounted thereon an internal combustion engine disposed toward the front end of the truck chassis and having a drive output, steerable front wheels, a rear differential and rear axle assembly having a main input, rear drive wheels mounted on the rear differential and rear axle assembly; b) connecting the mechanical input of a electric generator in driven relation to the drive output of the internal combustion engine; c) connecting the electric input of an electric drive motor in electrically conductive relation to the electrical output of the electric generator; d) connecting the mechanical output of the electric drive motor in driving relation to the main input of the rear differential and drive axle assembly; wherein the rear drive wheels are drivable by the internal combustion engine through the electric generator, the electric drive motor, the electric drive motor and the differential and axle assembly; e) mounting a debris hopper on the pre-built conventional truck chassis; f) mounting a debris loading apparatus on the pre-built conventional truck chassis rearwardly of the front steerable wheels and forwardly of the rear drive wheels; and g) connecting the debris loading apparatus in debris depositing relation to the debris hopper.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described herein below.

### BRIEF DESCRIPTION OF THE DRAWINGS

The novel features which are believed to be characteristic of the single-engine surface cleaning vehicle according to the present invention, as to its structure, organization, use and method of operation, together with further objectives and advantages thereof, will be better understood from the following drawings in which a presently first preferred embodiment of the invention will now be illustrated by way of example. It is expressly understood, however, that the drawings are for the purpose of illustration and description only, and are not intended as a definition of the limits of the invention. In the accompanying drawings:

FIG. 1 is a top plan view of the first preferred embodiment of the single-engine surface cleaning vehicle according to the present invention; and,

FIG. 2 is a top plan view of the second preferred embodiment of the single-engine surface cleaning vehicle according to the present invention.

### DETAILED DESCRIPTION OF THE PREFERRED EMBODIMENTS

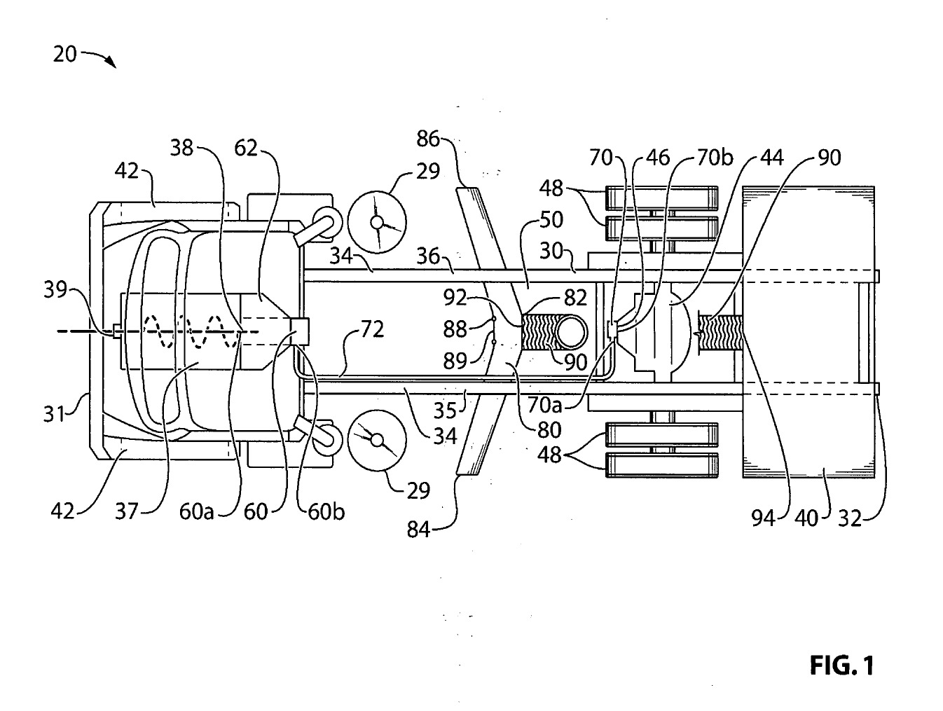

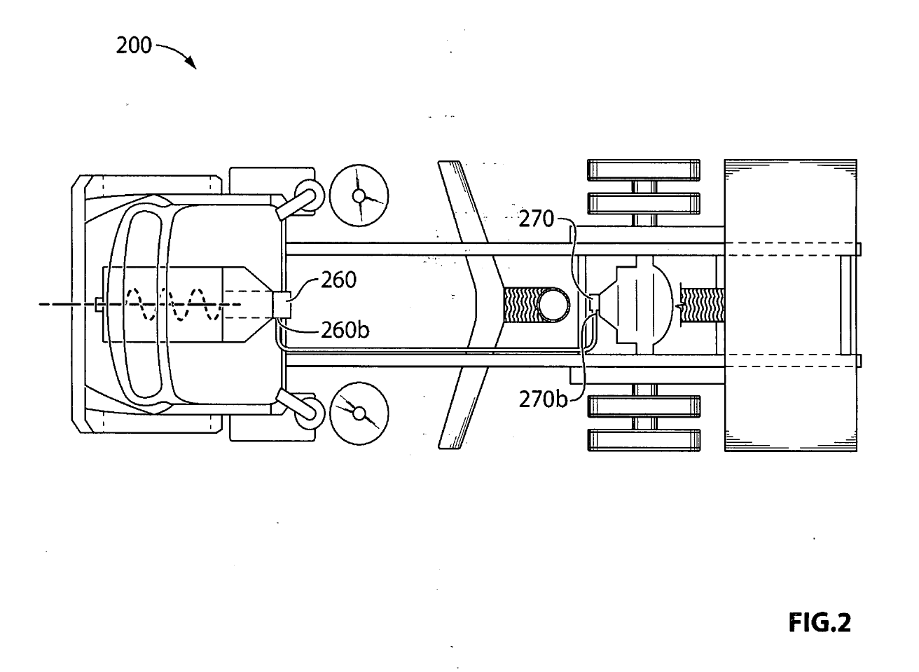

Referring to FIGS. 1 and 2 of the drawings, it will be noted that FIG. 1 illustrates a first preferred embodiment of the single-engine surface cleaning vehicle of the present invention, and FIG. 2 illustrates a second preferred embodiment of the single-engine surface cleaning vehicle of the present invention.

Reference will now be made to FIG. 1, which shows a first preferred embodiment of the single-engine surface cleaning vehicle of the present invention, as indicated by general reference numeral 20. The first preferred embodiment single engine surface cleaning vehicle 20 comprises a pre-built conventional truck chassis 30 defining a front end 31 and back end 32, and has a frame 34 with a left frame rail 35 and a right frame rail 36 laterally separated one from the other by a distance of about two feet or so. The pre-built conventional truck chassis 30 has mounted thereon an internal combustion engine 37 disposed toward the front end 31 of the truck chassis 30. The internal combustion engine 37 may be gasoline or diesel powered, and has a drive output 38 at its back end 32. Alternatively, a secondary drive output 39 at the front of the internal combustion engine 37 could be used.

There is also a debris hopper 40 mounted on the pre-built conventional truck chassis 30. Preferably, but not necessarily, the hopper 40 is disposed toward the back end 32 of the truck chassis 30.

The pre-built conventional truck chassis 30 is used because the overall construction of such conventional truck chassis 30 has been proven to be extremely over a number of years. Further, conventional truck chassis 30 are fully certified, as are all of the included components and sub-systems, as necessary.

As in virtually any conventional truck chassis 30, there are also steerable front wheels 42, a rear differential and rear axle assembly 44 having a main input 46, and rear drive wheels 48 mounted on the rear differential and rear axle assembly 44.

As can be readily seen in the Figures, there is a generally open space 50 in the truck chassis 30 between the left frame rail 35 and right frame rail 36, rearwardly of the internal combustion engine 37 and forwardly of the rear differential and rear axle assembly 44. In the first preferred embodiment, as illustrated, there is no drive shaft in the generally open space 50 in the truck chassis 30 between the left and right frame rails 35,36. Further, there is no transmission in the generally open space 50 in the truck chassis 30 between the left and right frame rails 35,36.

The single-engine surface cleaning vehicle 20 further comprising a power take off unit 33 having a mechanical input 33a connected in driven relation to the drive output 38 of the internal combustion engine 37, and a mechanical output 33b. The mechanical input 60a of the hydraulic pump 60 is connected in driven relation to the mechanical output 33a of the power take off unit 33, thereby connecting the mechanical input 60a of the hydraulic pump 60 in driven relation to the drive output 38 of the internal combustion engine 37.

A hydraulic pump 60 is mounted on the engine, preferably on or within a bell housing 62 or the like, and has a mechanical input 60a operatively connected in driven relation to the drive output 38 the internal combustion engine 37. More specifically, the mechanical input 60a of the hydraulic pump 60 is connected to the mechanical output 33b of the power take-off unit 33. The hydraulic pump 60 also has a hydraulic output 60b. Preferably, the hydraulic pump 60 comprises a variable displacement hydraulic pump 60.

A hydraulic drive motor 70 is mounted on the rear differential and rear axle assembly 44 and has a hydraulic input 70a connected in hydraulic relation to the hydraulic output 60b of the variable displacement hydraulic pump 60 via a hydraulic line 72. The hydraulic drive motor 70 also has a mechanical output 70b connected in driving relation to the main input 46 of the rear differential and rear axle assembly 44. More specifically, in the first preferred embodiment, as illustrated, the mechanical output 70b of the hydraulic drive motor 70 is connected in driving relation directly to the main input 46 of the rear differential and drive axle assembly 44. The rear drive wheels 48 are drivable by the internal combustion engine 37 through the drive output 38 of the internal combustion engine 37, the power take-off unit 33, the hydraulic pump 60, the hydraulic drive motor 70 and the rear differential and rear axle assembly 44.

There is also a debris loading apparatus 80 mounted rearwardly of the front steerable wheels 42 and forwardly of rear drive wheels 48. The debris loading apparatus 80 is connected in debris depositing relation to the debris hopper 29. In the first preferred embodiment, as illustrated, the debris loading apparatus 80 comprises a “V”-shaped type pick-up head 80 that is operatively mounted on the truck chassis 30 rearwardly of the steerable front wheels 42 and forwardly of the rear differential and rear axle assembly 44 and rear drive wheels 48. Alternatively, the “V”-shaped type pick-up head 80 maybe mounted on the truck chassis 30 in another location such as rearwardly of the rear differential and axle assembly 44 and the rear drive wheels 48.

A pair of gutter brooms 29 are mounted on the truck chassis 30 forwardly of the “V”-shaped type pick-up head 80 to sweep dirt and debris into the path of the “V”-shaped type pick-up head 80.

The pick-up head 80 has a dust and debris airflow outlet 82 that is disposed in the back of the pick-up head 80, and is generally centrally disposed between the left end 84 and the right end 86 of the pick-up head 80. The “V”-shaped type pick-up head 80 has a front dust and debris opening 88 that is generally centrally disposed between the left end 84 and the right end 86 of the pick-up head 80. The pick-up head 80 further comprises a door 89 operatively mounted at the front dust and debris opening 88.

There is also a main suctioning hose 90 having an inlet end 92 and an outlet end 94. The inlet end 92 of the main suctioning hose 90 is connected in fluid communication with the dust and debris airflow outlet 82 of the pick-up head 80. As can be readily seen in the Figures, the main suctioning hose 90 extends through the generally open space 50 between the left frame rail 35 and right frame rail 36, and connects at its outlet end 94 in debris depositing relation to the hopper 40. It can readily be seen that the omission of a drive shaft (not shown) and a transmission (not shown) permits the existence of the generally open space 50 in the truck chassis 30 between the left frame rail 35 and right frame rail 36, thus allowing the main suctioning hose 90 to extend from the dust and debris airflow outlet 82 of the pick-up head 80 to the hopper 40.

The present invention also comprises a method of manufacturing a surface cleaning vehicle 20 comprising the steps of providing a pre-built conventional truck chassis 30 defining a front end 31 and back end 32, and having a frame 34 with left and right frame rails 35,36, and having mounted thereon an internal combustion engine 37 disposed toward the front end 31 of the truck chassis 30 and having a drive output 38, steerable front wheels 42, a rear differential and rear axle assembly 44 having a main input 46, rear drive wheels 48 mounted on the rear differential and rear axle assembly 44; connecting the mechanical input 60a of a hydraulic pump 60 in driven relation to the drive output 38 of the internal combustion engine 37; connecting the hydraulic input 70a of a hydraulic drive motor 70 in hydraulic relation to the hydraulic output 60b of the hydraulic pump 60; connecting the mechanical output 70b of the hydraulic drive motor 70 in driving relation to the main input 46 of the rear differential and drive axle assembly 44.

As can readily be seen in the figures, the rear drive wheels 48 are drivable by the internal combustion engine 37 through the variable displacement hydraulic pump 60, the hydraulic drive motor 70 and the rear differential and rear axle assembly 44.

Subsequent steps include mounting a debris hopper 40 on the pre-built conventional truck chassis 30; mounting a pick-up head 80 rearwardly of the steerable front wheels 42 and forwardly of the rear differential and rear axle assembly 44; connecting the inlet end 92 of a main suctioning hose 90 in fluid communication to the dust and debris airflow outlet 82 of the pick-up head 80; and installing the main suctioning hose 90 through the generally open space 50 in the truck chassis 30 such that the main suctioning hose 90 connects at its outlet end 94 in debris depositing relation to the hopper 40.

Reference will now be made to FIG. 2, which shows a second preferred embodiment of the single-engine surface cleaning vehicle according to the present invention, as indicated by reference numeral 200. The second preferred embodiment single-engine surface cleaning vehicle 200 is similar to the first preferred embodiment single-engine surface cleaning vehicle 20, except that the second preferred embodiment the single-engine surface cleaning vehicle 200 has an electric generator 260 with an electrical output 260b in place of a hydraulic pump with a hydraulic output. Further, there is electric drive motor 270 having an electric input 270a connected in electrically conductive relation to the electric output of said electric generator, in place of the hydraulic drive motor.

Preferably, the steps of the method according to the present invention further comprise the steps of precluding a drive train from being connected in driven relation to the internal combustion engine, and precluding a transmission from being connected in driven relation to the internal combustion engine.

In an alternative embodiment, it is contemplated that the hydraulic drive motor could have its mechanical output connected in driving relation to the drive input of the rear differential and drive axle assembly.

As can be understood from the above description and from the accompanying drawings, the present invention provides a single internal combustion engine surface cleaning vehicle that can be driven at appropriately slow speeds while cleaning heavy debris and make available sufficient power for the cleaning apparatus, and that is inherently less expensive to produce than prior art models, all of which features are unknown in the prior art.

Other variations of the above principles will be apparent to those who are knowledgeable in the field of the invention, and such variations are considered to be within the scope of the present invention. Further, other modifications and alterations may be used in the design and manufacture of the single-engine surface cleaning vehicle of the present invention without departing from the spirit and scope of the accompanying claims.

I claim:

1. A single-engine surface cleaning vehicle comprising:
a pre-built conventional truck chassis defining a front end and back end, and having mounted thereon an internal combustion engine disposed toward the front end of the truck chassis and having a drive output, steerable front wheels, a rear differential and rear axle assembly having a main input, and rear drive wheels mounted on said rear differential and rear axle assembly;
a hydraulic pump having a mechanical input connected in driven relation to the drive output of said internal combustion engine, and a hydraulic output;
a hydraulic drive motor having a hydraulic input connected in hydraulic relation to the hydraulic output of said hydraulic pump, and a mechanical output connected in driving relation to the main input of said rear differential and drive axle assembly;
wherein said rear drive wheels are drivable by said internal combustion engine through said drive output of said internal combustion engine, said hydraulic pump, said hydraulic drive motor and said differential and axle assembly;
a debris hopper mounted on said pre-built conventional truck chassis; and,
a debris loading apparatus operatively mounted on said pre-built conventional truck chassis, and connected in debris depositing relation to said debris hopper.

2. The single-engine surface cleaning vehicle of claim 1, wherein said debris loading apparatus comprises a pick-up head.

3. The single-engine surface cleaning vehicle of claim 2, wherein said pick-up head comprises a “V”-shaped type pick-up head.

4. The single-engine surface cleaning vehicle of claim 1, wherein said mechanical output of said hydraulic drive motor is connected in driving relation directly to the main input of said rear differential and drive axle assembly.

5. The single-engine surface cleaning vehicle of claim 1, further comprising a power take-off unit having a mechanical input connected in driven relation to the drive output of said internal combustion engine, and wherein the mechanical input of said hydraulic pump is connected in driven relation to the mechanical output of said power take-off unit, thereby connecting the mechanical input of a hydraulic pump in driven relation to the drive output of said internal combustion engine.

6. The single-engine surface cleaning vehicle of claim 1, wherein said pre-built conventional truck chassis has a frame with left and right frame rails.

7. The single-engine surface cleaning vehicle of claim 6, further comprising a generally open space in said chassis between said left and right frame rails, rearwardly of said internal combustion engine and forwardly of said rear differential and rear axle assembly.

8. The single-engine surface cleaning vehicle of claim 1, wherein said debris loading apparatus is mounted rearwardly of said front steerable wheels.

9. The single-engine surface cleaning vehicle of claim 8, wherein said debris loading apparatus is mounted forwardly of said rear drive wheels.

10. The single-engine surface cleaning vehicle of claim 1, wherein said hydraulic pump comprises a variable displacement hydraulic pump.

11. A method of manufacturing a single-engine surface cleaning vehicle, said method comprising the steps of:
a) providing a pre-built conventional truck chassis defining a front end and back end, and having mounted thereon an internal combustion engine disposed toward the front end of the truck chassis and having a drive output, steerable front wheels, a rear differential and rear axle assembly having a main input, rear drive wheels mounted on said rear differential and rear axle assembly;
b) connecting the mechanical input of a hydraulic pump in driven relation to the drive output of said internal combustion engine;
c) connecting the hydraulic input of a hydraulic drive motor in hydraulic relation to the hydraulic output of said hydraulic pump;
d) connecting the mechanical output of said hydraulic drive motor in driving relation to the main input of said rear differential and drive axle assembly;
wherein said rear drive wheels are drivable by said internal combustion engine through said drive output of said internal combustion engine, said hydraulic pump, said hydraulic drive motor and said differential and axle assembly;
e) mounting a debris hopper on said pre-built conventional truck chassis;
f) operatively mounting a debris loading apparatus on said pre-built conventional truck chassis; and,
g) connecting said debris loading apparatus in debris depositing relation to said debris hopper.

12. The method of claim 11, further comprising the step of connecting the input of a power take-off unit in driven relation to the drive output of said internal combustion engine, and connecting the mechanical input of said hydraulic pump in driven relation to the mechanical output of said power take-off unit, thereby connecting the mechanical input of a hydraulic pump in driven relation to the drive output of said internal combustion engine.

13. The method of claim 11, wherein said hydraulic pump comprises a variable displacement hydraulic pump.

14. The method of claim 11, wherein said debris loading apparatus comprises a pick-up head.

15. The method of claim 11, wherein said debris loading apparatus is operatively mounted on said pre-built conventional truck chassis rearwardly of said front steerable wheels.

16. The method of claim 15, wherein said debris loading apparatus is operatively mounted on said pre-built truck chassis forwardly of said rear drive wheels.

17. A single-engine surface cleaning vehicle comprising:
a pre-built conventional truck chassis defining a front end and back end, and having mounted thereon an internal combustion engine disposed toward the front end of the truck chassis and having a drive output, steerable front wheels, a rear differential and rear axle assembly having a main input, and rear drive wheels mounted on said rear differential and electric generator rear axle assembly;
an electric generator having a mechanical input connected in driven relation to the drive output of said internal combustion engine, and an electrical output;
an electric drive motor having an electric input connected in electrically conductive relation to the electric output of said electric generator, and a mechanical output connected in driving relation to the main input of said rear differential and drive axle assembly;
wherein said rear drive wheels are drivable by said internal combustion engine through said electric generator, said electric drive motor, said electric drive motor and said differential and axle assembly;
a debris hopper mounted on said pre-built conventional truck chassis; and,
a debris loading apparatus operatively mounted on said pre-built conventional truck chassis, and connected in debris depositing relation to said debris hopper.

18. A method of manufacturing a single-engine surface cleaning vehicle, said method comprising the steps of:
a) providing a pre-built conventional truck chassis defining a front end and back end, and having mounted thereon an internal combustion engine disposed toward the front end of the truck chassis and having a drive output, steerable front wheels, a rear differential and rear axle assembly having a main input, rear drive wheels mounted on said rear differential and rear axle assembly;
b) connecting the mechanical input of an electric generator in driven relation to the drive output of said internal combustion engine;
c) connecting the electric input of an electric drive motor in electrically conductive relation to the electrical output of said electric generator;
d) connecting the mechanical output of said electric drive motor in driving relation to the main input of said rear differential and drive axle assembly;
wherein said rear drive wheels are drivable by said internal combustion engine through said electric generator, said electric drive motor, said electric drive motor and said differential and axle assembly;
e) mounting a debris hopper on said pre-built conventional truck chassis;
f) mounting a debris loading apparatus on said pre-built conventional truck chassis rearwardly of said front steerable wheels and forwardly of said rear drive wheels; and,
g) connecting said debris loading apparatus in debris depositing relation to said debris hopper.
